(19) United States
(12) Patent Application Publication
(10) Pub. No.: US 2012/0301840 A1
(43) Pub. Date: Nov. 29, 2012

(54) ENDODONTIC DEVICE

(76) Inventor: Daniele Poli, Serravalle Pistoiese PT (IT)

(21) Appl. No.: 13/512,882

(22) PCT Filed: Dec. 1, 2010
(86) PCT No.: PCT/IB10/55527

§ 371 Date: Jul. 18, 2012

(30) Foreign Application Priority Data
Dec. 4, 2009 (IT) RM2009A000642

(51) Int. Cl. A61C 5/02

(52) U.S. Cl. 433/27

(57) ABSTRACT

An endodontic device is described including: a file adapted to remove by abrasion the dental material by a rotary working motion; an AC or DC motor, adapted to drive the file in the working motion according to two opposite verses of rotation; a pair of optical or magnetic encoders controlling a position mounted in quadrature of the driving shaft, to evaluate the angular position of the file and consequently control the motor.

The present invention relates to an endodontic device apt to perform canal treatments.

On the market there are endodontic devices mainly comprising a root canal instrument apt to remove by abrasion the dental surfaces, in particular one or more interchangeable files, and an associated motor to drive such instrument according to a pre-established, typically unidirectional rotary working motion.

In particular, different types of micromotors are used, dedicated to the endodontic treatments, all of them with very similar features linked to the type of file which the device uses during the work. The used motors, however, have all the rotation speed of the file comprised within 100 and 800 revolutions per minute with maximum torque limitation around 8 Ncm.

In general terms, the known devices have the possibility of making the file to rotate both in a main working verse and in the opposite verse, but in the latter case only for the time needed to disengage the instrument which had got jammed in the working material and thus without cutting capability.

In recent times a root canal instrument has been developed, suitable to the oscillating motion and which requires specific values of rotation speed and angle travelled in both verses. However, also in this case, the cutting capability remains nevertheless only during the clockwise running, whereas in the counterclockwise direction the removal of the working residues is favoured.

The development of devices able to provide to the root canal instrument an effective rotational working motion in both verses would be instead desirable to increase the useful life of the instrument itself—particularly with respect to the ruptures due to torsional fatigue—and in general the reliability of the device as a whole. However, as illustrated above, no one of the known instruments, to say the truth, provides such bi-directionality in the real working motion and even the devices which have some capability of oscillating motion in the verse illustrated above result to be little satisfying for the capability in reproducing the required working specifications.

Regarding this latter aspect, it is to be noted that several models use a DC motor and exploit the counter-electrodriving force value to determine the motor speed and therefore they trace the file position by measuring the rotation time. However, the fluctuations due to the load variability cause errors which cannot be compensated as a reference retroaction of the position does not exist.

As far as the control based upon the motor torque is concerned, the motion quickness on one side prevents an accurate measurement of the torque and on the other side it auto-limits the development thereof as there is no sufficient time to stabilize above the inertias.

CH 670756 describes a dental device comprising an abrasive member with angular motion limited to a range of 20°. Such instrument provides a reference point on the abrasive member to detect the position thereof.

WO 2005/037124 describes a dental device comprising an abrasive member and magneto-resistive sensors or sensors with Hall effect to determine the angular position of a rotor of the instrument itself in an angular range comprised between 0° and 90°.

The technical problem placed and solved by the present invention is to provide an endodontic device allowing to obviate the drawbacks mentioned above with reference to the known art.

Such problem is solved by a device according to claim 1.

Preferred features of the present invention are present in the claims depending upon the same.

The present invention provides some important advantages. The main advantage consists in the fact that the proposed endodontic device allows an effective rotary working motion in both running verses on wide angular ranges, and this thanks to an optical or magnetic position control performed by means of encoder. This type of control guarantees maximum precision to the angular position of the root canal instrument, typically a file.

In a preferred way, the device provides a secondary control of the rotation speed, to guarantee that, apart from the surrounding conditions, this keeps constant and, in a further preferred way, a torque control to avoid that the motor can stall, by protecting the device from overcurrents or overtemperatures.

Other advantages, features and use modes of the present invention will be evident from the following detailed description of some embodiments, shown by way of example and not with limitative purpose. The drawings of the enclosed figures will be referred to, wherein:

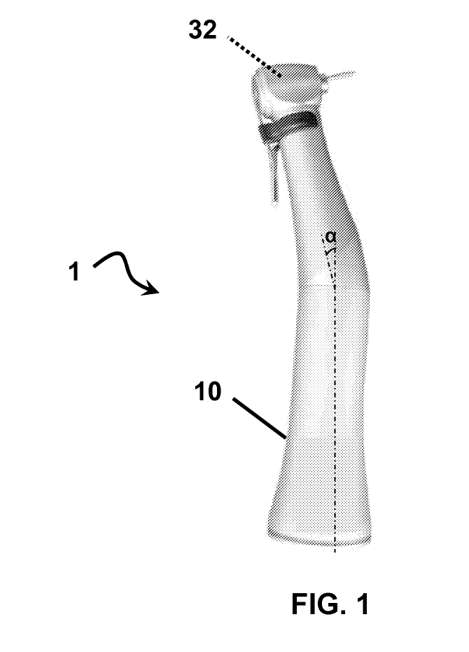

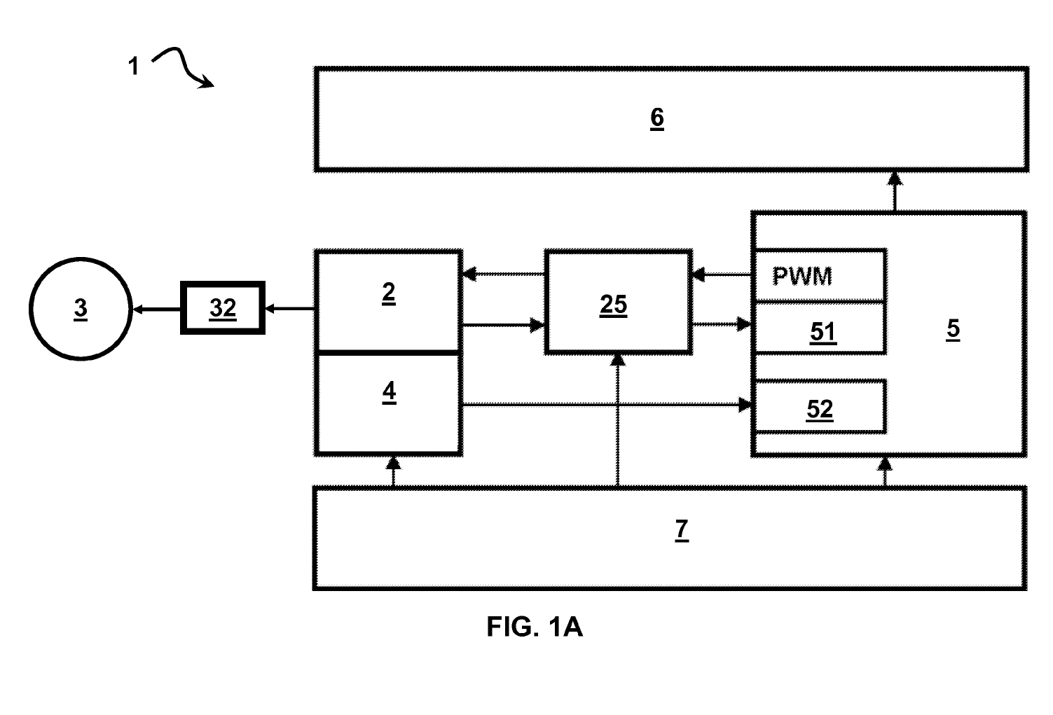

FIG. 1 shows a perspective side view exemplifying an endodontic device according to a preferred embodiment of the present invention;

FIG. 1A shows a block diagram of the device of FIG. 1; and

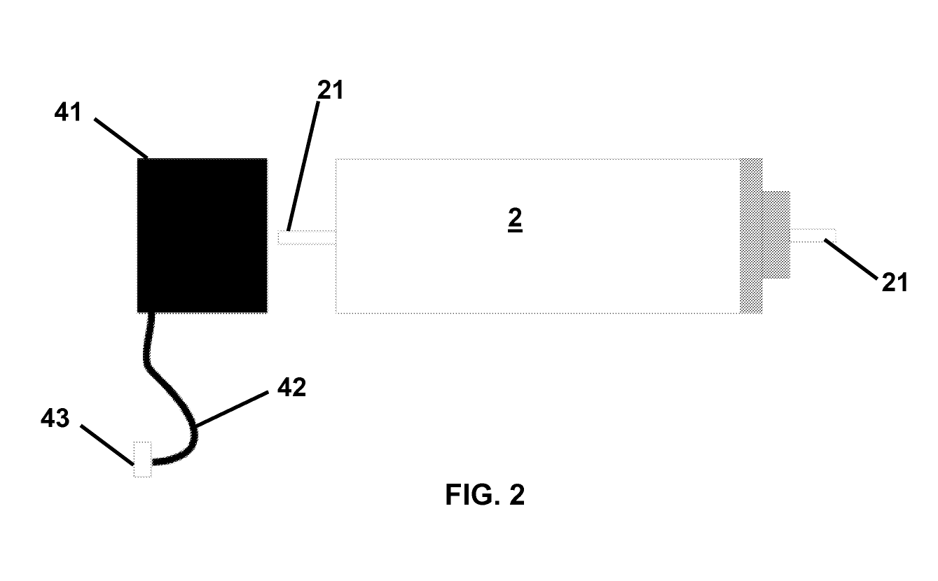

FIG. 2 shows an exploded schematic side view of an encoder associated to a motor of the device of FIG. 1.

By referring to FIGS. 1 and 1A, an endodontic device according to a preferred embodiment of the invention is designated as a whole with 1.

The device 1 comprises a main body 10 shaped like a handpiece.

Within the main body 10, the device 1 comprises driving means 2 apt to drive in rotation a root canal instrument 3, in the present example a file, by means of possible interposition of motion transmitting means 32, in particular a reducer of type known in itself.

The driving means 2 can be made, for example, of a AC, DC or BLDC (“Brushless DC”) motor or micromotor, of known type on itself and therefore not further described in this seat.

Preferably, the reducer 32 has a typical fold (counterangle) α of about 21° to allow to work on the file 3 perpendicularly to the tooth surface. Preferably, (not represented) means is provided to compensate the special backlashes of the gears of the reducer 32 in case this is of mechanical type.

In the present example, the reducer 32 has a reduction ratio 6:1.

Means for detecting the position and the torque is associated to the motor 2. In FIG. 1A this latter has been represented—by simplicity and by simple way of example—as incorporated in a same block and designated as a whole with 4. Such detection means 4 will be described shortly in greater detail.

The device 1 comprises then a control unit 5, typically implemented by means of a microprocessor in case incorporated in the same motor 2 and represented as separated functional block in FIG. 1A. The control unit 5 can be connected to a user interface 6, which can have the function of simple information or allow a bidirectional data exchange between control unit 5 itself and indeed a user, thus allowing in this second case to select the working data and to control the state of settings.

The higher or less complexity of the interface 6 can depend upon commercial needs and it affects the choice of the resources of the control unit 5.

By way of example, in FIG. 1A between the control unit 5 and the motor 2 a driver member 25 in bidirectional communication the two units has been represented.

The driver member 25 can be controlled by means of a signal of the type with pulse width modulation (so-called “PWM”).

Still by way of example, in FIG. 1A the device 1 is represented as incorporating even power supply means 7, in communication both with the control unit 5 and with the motor 2 and the driver 25.

In functional terms, the control unit 5, by means of the driver member 25, controls and drives the power supply of the motor 2 according to the signals received from properly processed detection means 4. In particular, in FIG. 1A two different inputs in the control unit 5, designated with 51 and 52, respectively, and dedicated to a torque signal delivered by the motor 2 and to a position control signal, respectively, are represented.

Now greater details of the above-mentioned torque and position detections performed by the means 4 will be given.

The detection means 4 is handled by means of the above-mentioned dedicated feedback inlets 51 and 52, that is by means of the inlets, which once initialized, work autonomously, without engaging additional resources of the microprocessor implementing the control unit 5.

In particular, at the torque inlet 51 a signal is received which measures a voltage proportional to the torque delivered by the motor 2. Such reading can be made directly on the motor, but this involves the need of filtering the signal from the electric noise generated by the motor itself and making the reading in pre-established times synchronized with the PWM signal driving the driver member 25. For this reason, a preferred embodiment variant, thereto FIG. 1A relates, provides that the torque detection means is incorporated in the same driver 25. In particular, the latter has aboard circuits able to measure a voltage proportional to the delivered torque, by performing even all the procedures necessary to filter the signal and thus freeing hardware and software resources of the control unit 5.

As shown in FIG. 2, in the present embodiment the position detection means is based upon an optical or magnetic encoder 41 mounted directly on a driving shaft 21 of the driving means 2, upstream of the reducer 32 and in particular at an end of such driving shaft 21 opposite to the one opposed to the one connected to the reducer itself.

In a preferred embodiment such encoder 41 is constituted by a rotating disk with holes, for example 64, equally spaced on the circumference, associated to a fixed light-emitting led opposing to a light-detecting diode, fixed too, providing a voltage variation each time the intensity of the beam striking it is varied.

Placing a second analogous disk-led-diode group, arranged staggered by 90° with respect to the first one (that is in quadrature with the latter) allows to double the resolution and to detect in which verse the driving shaft rotates.

Preferably, the processing of the detected angular position signal acts on both edges of the signal coming from the sensors (that is both on the “positive” step corresponding to a light detection by the diode and on the “negative” step corresponding to the signal absence).

The reading of the pulses provided by the encoders in pre-established time ranges provides directly, at the level of the control unit 5, the measurement of the instantaneous rotation speed of the driving shaft and therefore, with proper processings within the comprehension of the person skilled in the art, of the final instrument 3. Therefore, according to the invention the position of the driving shaft 21 is detected with the purpose of controlling the position of the instrument 3, as this latter position can be deducted directly from the one of the driving shaft 21 itself.

According to the same criteria and by comparing instantaneous angular speeds related to different moments, a calculation of the angular acceleration is also possible.

Still at the level of the control unit 5, by means of proper software means, an algorithm controlling the driving means 2 is also implemented, apt to provide the requested motion to the final root canal instrument 3.

On this matter, the algorithm can calculate the difference between actual position and previous position to generate an error signal and with this to correct the value of the motor power supply voltage or to compare the detected position values with the expected position values and, with this difference, to generate the above-mentioned error signal.

Still in FIG. 2, a cable 42 and a connector 43 associated to the encoder 41 are shown.

A numerical application example will be now proposed to better illustrate the advantages of the invention.

In the above-mentioned case of 64 holes for each encoder disk, in a revolution 64 different situations are noted. The choice of 64 pulses/revolution allows a greater resolution even in presence of small reductions.

In particular, in the considered example 128 edges are available for each sensor, that is 256 overall pulses per revolution of the driving shaft. Therefore, a resolution at the shaft of 360°:256=1.46° is obtained for each edge, both leading and trailing one. With a reducing handpiece 6:1 a resolution at the file of 0.24° is obtained, whereas with a reducing handpiece 16:1 of about 0.10°. It will be appreciated that such resolution is clearly higher than the one allowed, for example, by the sensors with Hall effect of known art.

By considering a maximum rotation speed of 500 rpm for the file 3, with a reducing handpiece 6:1, 3000 rpm at the shaft result, whereas with 16:1 8000 rpm at the shaft result. In the worst use case with a reducing handpiece 20:1, pulses every 0.5 ns are obtained.

By way of example, if the mechanical time constant of the motor 2 is 7.74 ms and the frequency of PWM is 20 kHz—therefore with a period of 50 μs—the correction of the programmed PWM value is made every 2 ms, by following an “interrupt” generated by a timer inside the control unit 5.

As said above, the described solution allows handling both a unidirectional rotating motion and a reciprocating motion.

In case of rotating motion, the adoption of the above-mentioned encoders, preferably in association with a control unit 5 with microprocessor for example with 16 bit, allows controlling the speed with greater precision, by avoiding overelongations in the time course of the speed itself, as the acceleration and the deceleration can be handled in very short time, thus obtaining a greater control efficiency.

As far as the reciprocating motion is concerned, it is possible avoiding a control based upon the torque, not recommended as the motor is obliged to stop and re-start continuously in opposite direction. In fact, in this situation the motor is subjected to an initial acceleration with immediate current raise and subsequent decrease until steady state current, due to the inductance of the windings which reacts, in the acceleration phase, as counter-electromotive force generator and therefore, in substance, of a countercurrent which adds to the one provided by the power circuit. A reliable current indication would be available when the motor has reached the steady state speed, that is little before stopping and rotating in the opposite direction. In this instant the current has a very steep course, with formation of a raising peak and a subsequent descending peak following the inversion of the rotation verse to be then symmetrical to what stated above. It follows that a reliable current measurement is possible only under condition of synchronism between performing the reading and the motor position, so as to perform readings only in the period of time wherein the rotation is uniform.

The clinical practice, however, suggests that by operating with files in reciprocating motion, it is right not to put limits to the machine power as the abrasion of the dental channel takes place with a rotation of the file itself limited between 60° and 180° and in this route range the instrument undergoes a minimum torsion with limited fatigue of the instrument itself. On the other side, the reciprocating motion is created to decrease the torsional fatigue of the file when it is inside the channel.

In the retrograde rotation, then, the file is not subjected to effort as in this phase, by the effect of the its screw-like shape with very elongated pitch, it only has to favour the outletting of the abraded debris from the dental channel.

In the device 1 as described sofar, current measurements are performed during the time within this has stabilized, not to perform corrections in motion or elongation, but only to control that there is no excessive effort which is interpreted as the fact that the file is immobilized in the end portion and instead is made to rotate in the initial portion, thus creating a torsion which, in the long term, could damage the fibres of the file itself.

The control unit 5, together with the detection means 4, further comprises software and/or hardware means apt to detect a jamming of the root canal instrument 3, so as to interrupt the operation thereof by the motor 2 or to reverse the verse of the working motion. Preferably, such jamming means is associated to warning means, for example of acoustic type, which activates when such event occurs.

By describing in greater technical details the last feature, the motor stall situation (which clearly corresponds to the jamming of the instrument 3) is felt by the microprocessor implementing the control unit 5 as the occurrence of more events in concomitant periods of time. In particular, in the present example, the microprocessor performs a check of the motion situation every 2 ms. It is able to interpret as motor stall a situation wherein the position error, measured as difference between the desired position of the driving shaft 21 and the actual position, keeps higher than a pre-established value for a period of time equal to the double of the motor mechanical time constant, if such situation occurs at the same time of an increase in the current absorbed by the motor. Practically, the parameters highlighting the so-called motor “escape of axes” are controlled. Once identified the “escape” situation, the control unit 5 establishes the impossibility of restoring the requested position/speed profile and it performs one of the actions therefor it has been programmed chosen among:
reversal of the rotation limit angles,
stop with motor braking,
stop without motor braking,
stop with or without motor braking and restart counterclockwise,
stop with or without motor braking and restart counterclockwise for a pre-established period of time, then motor stop,
stop with or without motor braking and restart counterclockwise for a pre-established period of time and then prosecution in the normal rotation direction.

It will be appreciated that the device 1 described above can be implemented with very few components, as the necessary functions can be all integrated and implemented inside the integrated circuits, thus allowing to save energy and by making possible to power supply the device even by means of batteries which leave some hours of autonomy to the end user.

The present invention has been described sofar with reference to preferred embodiments. It is to be meant that other embodiments can exist, belonging to the same inventive core, as defined by the protection scope of the claims illustrated hereinafter.

1. An endodontic device (1), comprising:
a root canal instrument (3), apt to remove by abrasion the dental material by a rotary working motion;
driving means (2), apt to drive said root canal instrument (3) in said working motion according to two opposite verses of rotation; and
means (4, 5) for controlling the position of said root canal instrument (3), apt to act upon said driving means (2) and comprising means for measuring an angular position (4),
wherein said means for measuring an angular position comprises one or more optical or magnetic encoders (4) arranged in correspondence of a driving shaft (21) of said driving means (2).

2. The endodontic device (1) according to claim 1, wherein said root canal instrument is a file (3).

3. The endodontic device (1) according to claim 1 or 2, comprising a reducer (32) combined with said driving shaft (21) downstream of said one or more encoders (4).

4. The endodontic device (1) according to the preceding claim, wherein said one or more encoders (4) are apt to provide indications about the verse of rotation of said root canal instrument (3).

5. The endodontic device (1) according to any one of the preceding claims, wherein said means for measuring an angular position comprises a pair of optical or magnetic encoders (4) arranged in quadrature each other.

6. The endodontic device (1) according to any one of the preceding claims, comprising means (5) for controlling the angular velocity of said root canal instrument (3), apt to provide, at steady state, a substantially constant angular velocity.

7. The endodontic device (1) according to any one of the preceding claims, comprising means (4, 5) for controlling the torque of said driving means (2), apt to protect the latter from overcurrents, overvoltages or overtemperatures.

8. The endodontic device (1) according to any one of the preceding claims, further comprising means (5) apt to detect a jamming of said root canal instrument (3) and to interrupt accordingly the working motion thereof or to reverse its direction.

9. The endodontic device (1) according to the preceding claim, further comprising warning means, e.g. of acoustic type, in case a jamming of said root canal instrument (3) is detected.
